(19) United States
(12) Patent Application Publication
(10) Pub. No.: US 2009/0284258 A1
(43) Pub. Date: Nov. 19, 2009

(54) AIRBORNE GEOPHYSICAL SURVEY USING AIRSHIP

(75) Inventors: Edward B. Morrison, Stouffville (CA); Bob Bak Lo, Markham (CA)

Correspondence Address: FAEGRE & BENSON LLP;PATENT DOCKETING - INTELLECTUAL PROPERTY, 2200 WELLS FARGO CENTER, 90 SOUTH SEVENTH STREET, MINNEAPOLIS, MN, 55402-3901, US

(73) Assignee: Geotech Airborne Limited, St. Michael (BB)

(21) Appl. No.: 12/120,328

(22) Filed: May 14, 2008

(51) Int. Cl. G01V 3/16; B64B 1/02; G01C 21/00; B64D 3/00; G05D 1/00

(52) U.S. Cl. 324/330; 244/30; 701/213; 244/1 TD; 701/2

(57) ABSTRACT

A method and system for geophysical surveying. A non-rigid airship having a self-supporting gas envelope and propulsion units coupled to the gas envelope, the propulsion units being configured to control the steering and altitude of the airship without the aid of a rudder or elevators, is provided with geophysical survey equipment, and geophysical data is collected while flying the airship. Also a method for geophysical surveying that includes providing a first airship with a first set of geophysical survey equipment, providing a second airship with a second set of geophysical survey equipment that is complimentary to the first set, and conducting an airborne geophysical survey by flying the first airship and the second airship along a designated flight path within a predetermined range of each other.

### BACKGROUND

Embodiments are described below that relate to the field of airborne geological mapping using an airship.

A number of different types of geophysical surveys can be conducted by air, including for example gravity surveys, magnetic field surveys, electromagnetic surveys (including both active EM surveys such as airborne Time Domain Electromagnetic (“TDEM”) surveys and passive EM surveys such as airborne audio frequency magnetic (“AFMAG”) surveys), and radiometry surveys.

Airborne geophysical surveys are typically conducted using survey platforms that are attached to or suspended from a survey aircraft that is an airplane or helicopter. Airplanes and helicopters are typically large metallic objects powered by powerful vibrating engines, and hence provide an operating environment that is not always conducive to highly sensitive geophysical survey equipment. Additionally, operating airplanes and helicopters can be expensive an inconvenient as they have limited fuel efficiency, and a limited range that necessitates access to an airfield or landing pad relatively close to a survey site.

Airships present an alternative platform for geophysical surveys. However, proposals for using airships for geographical surveys have focused on airships that have rigid internal support structures. The structure used in a rigid airship can also transmit noise from airship engines to geophysical survey equipment, and the airship support structure itself can be a conductive body that introduces noise.

Accordingly, improvements in airborne geophysical surveys are desired.

### SUMMARY

According to one example embodiment is a method for geophysical surveying that includes (a) providing a non-rigid airship having a self-supporting gas envelope and propulsion units coupled to the gas envelope, the propulsion units being configured to control the steering and altitude of the airship without the aid of a rudder or elevators; (b) providing geophysical survey equipment on the airship; and (c) collecting geophysical data using the geophysical survey equipment while flying the airship.

According to another example embodiment is a geophysical surveying system that includes a non-rigid first airship having a self-supporting gas envelope and propulsion units coupled to the gas envelope, the propulsion units being configured to control the steering and altitude of the first airship without the aid of a rudder or elevators; and geophysical survey equipment on the first airship.

According to another example embodiment is a method for geophysical surveying comprising providing a first airship with a first set of geophysical survey equipment; providing a second airship with a second set of geophysical survey equipment that is complimentary to the first set; and conducting an airborne geophysical survey by flying the first airship and the second airship along a designated flight path within a predetermined range of each other.

### BRIEF DESCRIPTION OF THE DRAWINGS

FIG. 1 illustrates a side elevation of an airborne geophysical survey system according to an example embodiment.

FIG. 2 is a side elevation of an airship of FIG. 1 according to an example embodiment.

FIG. 3 is an end elevation of the airship of FIG. 1.

FIG. 4 is a side elevation of a further embodiment of an airship according to example embodiments.

FIG. 5 is a top plan view of the airship of FIG. 4.

FIG. 6 is a front elevation of a propulsion unit for an airship according to example embodiments.

FIG. 7 is a side elevation, partially cut away of the propulsion unit of FIG. 6.

FIG. 8 is a perspective view of a propulsion unit and its mounting frame.

FIG. 9 is a block diagram representation of geophysical survey equipment that can be carried by the airships of FIGS. 1-5.

FIGS. 10a and 10b illustrate examples of geophysical survey flight patterns.

FIG. 11 illustrates the tow assembly of FIG. 1 in a perspective view.

FIG. 12 illustrates the tow assembly of FIG. 1 in a top view thereof.

FIG. 13 shows an enlarged portion of FIG. 12 illustrating a receiver section of the tow assembly.

FIG. 14 is a block diagram illustration of the electrical and processing components of an EM survey system.

FIG. 15 is a perspective view of an airborne geophysical survey system according to another example embodiment.

FIG. 16 is a side elevation of the airborne geophysical survey system of FIG. 15.

FIG. 17 is a side elevation of an airborne geophysical survey system according to another example embodiment.

FIG. 18 is a side elevation of an airborne geophysical survey system according to another example embodiment.

In the drawings, embodiments of the invention are illustrated by way of example. It is to be expressly understood that the description and drawings are only for the purpose of illustration and as an aid to understanding, and are not intended as a definition of the limits of the invention.

### DESCRIPTION OF EXAMPLE EMBODIMENTS

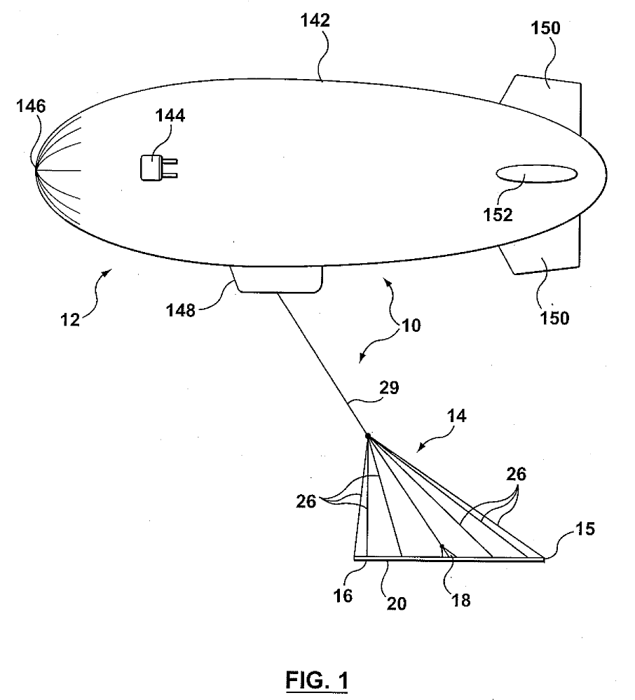

FIG. 1 illustrates an example embodiment of an airborne geophysical survey system 10. In the embodiment shown in FIG. 1, the survey system 10 includes an airship 12 and geophysical survey equipment that can include, among other things, a tow assembly 14.

Example embodiments of an airship 12 for carrying equipment for conducting a geophysical survey will first be discussed, followed by a description of example embodiments of geophysical survey equipment that can be used with the airship 12.

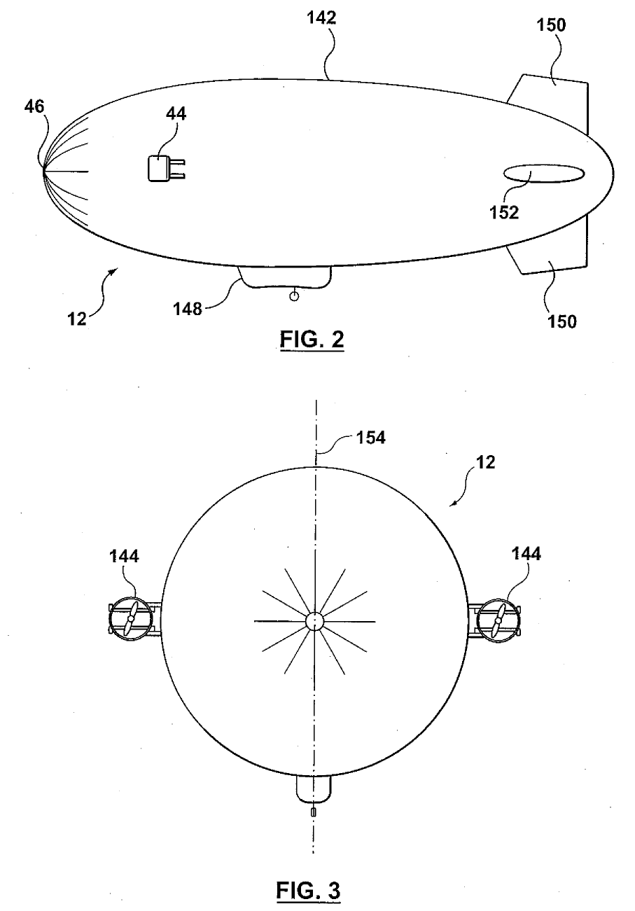

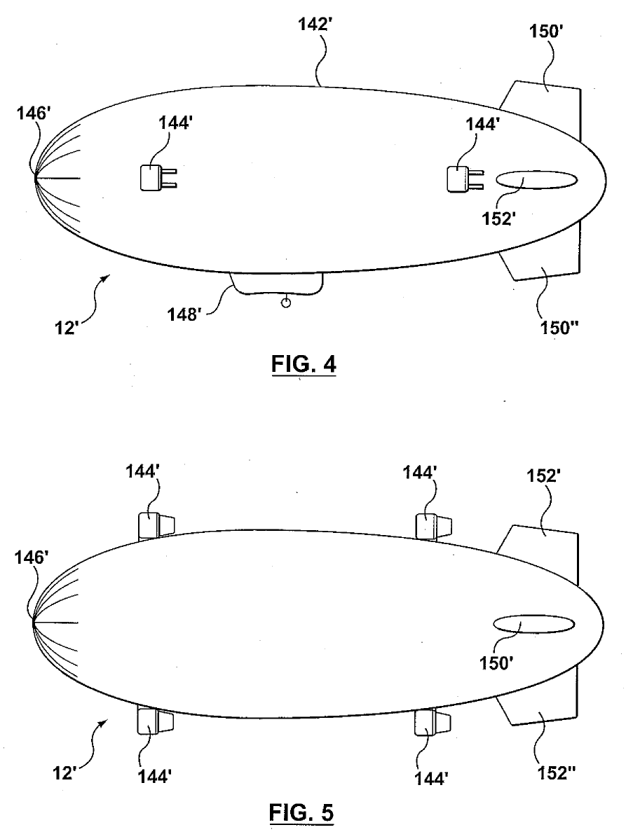

In at least some example embodiments, airship 12 is similar to the airships described in U.S. Pat. No. 5,294,076. In this regard, referring to FIGS. 2 and 3, in an example embodiment the airship 12 is a non-rigid airship that uses propulsion units for steering and altitude control rather than rudders or elevators. As a non-rigid airship, the airship 12 has a gas envelope 142 which defines its general shape. Airships that have their shape due to the pressure of a lifting-gas inside the gas envelope are of the non-rigid type, as opposed to airships that have their shape due to a rigid internal frame. The airship 12 has a pair of propulsion units 144, one on either side of the gas envelope 142, at generally diametrically opposed locations toward the front 146 of the airship 12 about one third of the way along the length of the airship 140. The position of the propulsion units 144 may vary depending on what type of geological surveying the airship 12 is used for and, accordingly, how it is to be loaded and therefore balanced. FIGS. 4 and 5 show an airship similar to that of FIGS. 2 and 3, with primed reference numerals indicating similar components. The airship 12′ of FIGS. 4 and 5 differs from the airship of FIGS. 2 and 3 in that pairs of propulsion units 144′ are provided both toward the front third and toward the rear third of the gas envelope 142′.

The overall shape of the airships 12 in FIGS. 2 and 3 and 12′ in FIGS. 4 and 5 is generally a cigar shape and the airships 12 and 12′ are provided with gondolas 148 and 148′ respectively suspended from their undersides, however in the illustrated embodiment the gondolas 148 and 148′ do not have engines attached to them. The airships 140 and 140′ are further provided with vertical fins 150 and 150′ respectively and horizontal fins 152 and 152′ toward the rear of the airships 140 and 140′. The fins 150, 150′, 152 and 152′ are provided primarily for stability and, as will be described below, are not used in maneuvering. Accordingly, elevators and rudders are not required on the airship design of FIGS. 1-5.

Altitude and directional control of the airships 12 and 12′ of FIGS. 1-5 is provided by controlling the amount and direction of thrust of the air emanating from the propulsion units 144 and 144′ respectively. The propulsion units 144 and 144′ and the deflection of their respective thrust will be described in more detail below.

The altitude of the airships 12 and 12′ in FIGS. 1-5 is controlled by directing thrust emanating from the propulsion units 144 and 144′ downwardly to increase the altitude and upwardly, to decrease the altitude. To steer the airships 12 and 12′, the thrust from the propulsion units 144 and 144′ on one side of the airship 12 or 12′ respectively may be increased or decreased relative to the thrust of the propulsion units 144 and 144′ on the opposite side of the airship 12 or 12′. Varying the relative thrust of the propulsion units 144 or 144′ will cause rotation of the airship about a generally vertical axis such as the axis 154 in FIG. 3.

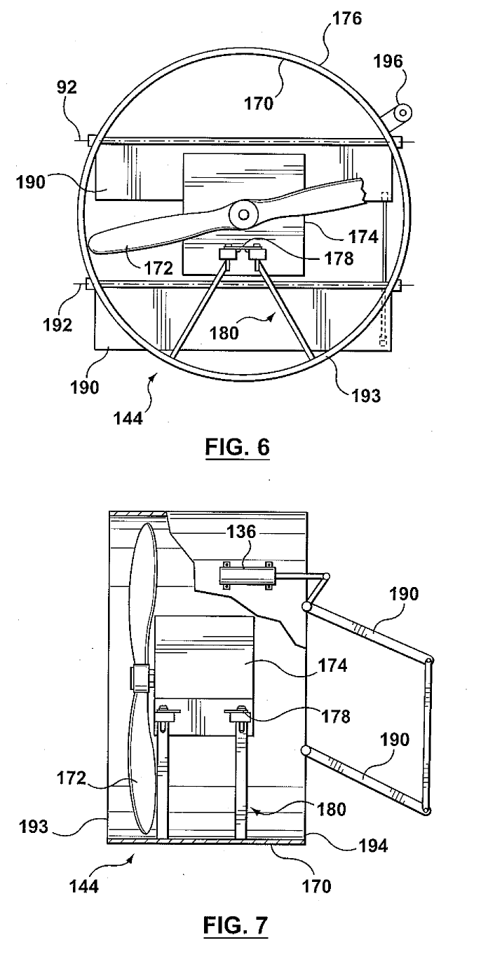

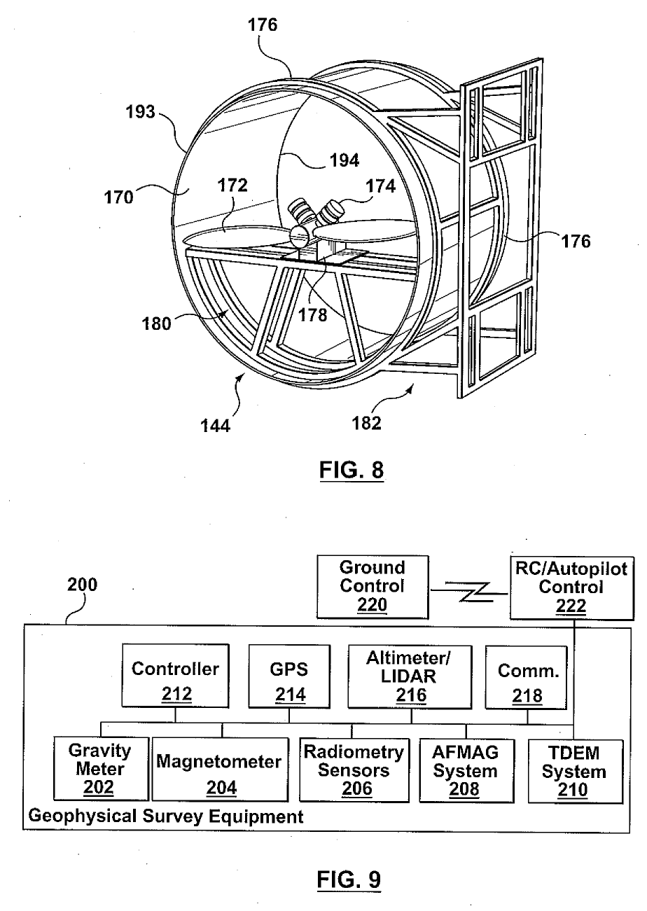

Referring to FIGS. 6, 7 and 8, example embodiments of the propulsion units 144, 144′ will now be described in more detail. The propulsion units are each generally a ducted fan. Accordingly, the propulsion unit has a generally cylindrical shroud 170 generally co-axial with and surrounding a propeller 172. An engine 174, which may be of internal combustion type, provides the necessary power to rotate the propeller 172. The shroud 170 may be of sheet metal and reinforced by a pair of hoops 176 extending therearound toward the ends of the shroud 170. The shroud has an inlet end 193 and an outlet end 194. The engine 174 may be mounted on a platform 178 supported inside of the shroud by a support frame 180. Portions of the support frame 180 have been omitted from FIGS. 6 and 7 to better illustrate the thrust deflection system which is described in more detail below. A mounting frame 182 in FIG. 8 extends from the side of the shroud 170, attaching to the reinforcing hoops 176. The mounting frame 182 enables the propulsion unit 144 to be attached to the gas envelope of the airship. Attachment of the propulsion units 144 to the gas envelope may be accomplished with a combination of fabric, such as the type from which the gas envelope, is made and straps, wrapped around the frame 182 and secured to the gas envelope. The propulsion unit may be further supported and stabilized by wire cables which extend between the propulsion units 144 and the gas envelope 142.

Deflection of the thrust from the propeller 172 of the propulsion unit 144 in a vertical direction may be achieved by horizontal flaps 190 in FIGS. 6 and 7 mounted across the outlet end 194 of the shroud or duct 170 surrounding the propeller 172. The flaps 190 are rotatable about a generally horizontal axis 192 by an actuating means, namely fluid cylinder 196. Although only two flaps are shown in FIGS. 6 and 7, the propulsion unit can have more that two flaps. It will be appreciated that other actuating means such as cables, electric motors, screw and screw followers may also be used.

It will be appreciated that as the altitudinal and directional control of the airship 12, 12′ is controlled by directing thrust from the propulsion units, the response of the airship to directional input will be relative to the thrust emanating from the propulsion units. As the thrust from the propulsion units may be varied by altering the speed or pitch of the propellers, maneuvering of the airship 12, 12′ relies less on airspeed than airships that make use of control surfaces for steering and altitude control and accordingly the airship 12, 12′ can be less cumbersome at relatively low speeds.

Variations to the structure and operation of the airship 12, 12′ may be apparent to those skilled in the art of airships and their navigation. For example, although thrust deflection systems utilizing flaps or nozzles have been described, as an alternative, it may be possible to move the thrust producing propulsion unit relative to the envelope. This may be accomplished by applying force directly to the propulsion unit and causing flexion in the envelope in the attachment region. Alternatively, the propulsion unit may be swivelably mounted to the mounting frame.

Now that a description of example embodiments of an airship have been provided, example embodiments of the geophysical survey equipment that can be carried by the non-rigid airship 12, 12′ will now be provided. FIG. 9 shows a block diagram representation of such geophysical survey equipment 200, which may include for example one or more of a gravity meter 202 for taking gravitational field readings, a magnetometer 204 for taking magnetic field readings, radiometry sensors 206 for taking various radio frequency measurements, a passive EM sensor in the form of AFMAG system 208 for measuring low frequency electromagnetic fields caused by to natural EM sources, and an active frequency domain or time domain electromagnetic geophysical survey system 210 (as will be discussed in greater detail below). In example embodiments, one or more of gravity meter 202, magnetometer 204, radiometry sensors 206, AFMAG system 208 and active electromagnetic survey system 210 can be implemented using known systems. By way of example, U.S. Pat. No. 6,876,202, incorporated herein by reference, discloses an example of a suitable AFMAG system 208. Geophysical survey equipment 200 can also include, among other things, a computer that acts as a system controller 212 (which may for example be used for system control, monitoring, survey planning and tracking, among other things), one or more Global Positioning System (GPS) sensors 214 for determining the location of the equipment 200 at any point in time, and a radar altimeter and a light detection and ranging (LIDAR) sensor 216 for determining altitude and range. The LIDAR sensor may include an inertial navigation system (INS). A two way communications system 218 (for example a two-way satellite link) can be provided for real-time or periodic transmission of measured data to a remote location and for receiving instructions.

All or parts of the geophysical survey equipment 200 can be located in the airship gondola 148, integrated into the airship structure, or towed. As the airship 12, 12′ is non-rigid and thus has no internal support structure, the airship produces relatively little noise to interfere with the survey equipment 200. Additionally, as the propulsion units 44 are attached to the gas envelope 42 and no rigid internal frame connects the gas envelope 42 to the gondola 148, the effects of any vibrations from the propulsion units on the gondola are extensively damped—this provides a relatively vibration free environment for geophysical survey equipment located in or suspended from the gondola.

In at least some example the non rigid gas envelope 42 is easily penetrated by signals from GPS satellites such that a GPS sensor 214 located under the gas envelope (for example in or on the gondola or suspended on equipment underneath the airship) can receive GPS signals without interference from the airship structure, allowing a true location reading for the actual geophysical survey equipment to be determined with greater accuracy.

A geophysical survey may be conducted using an airship 12, 12′ with the geophysical survey equipment 200 to cover large areas of land in an efficient manner. Within a turbulent environment, the airship 12, 12′ provides a calm surrounding for collecting data. For high quality measurements, a high signal-to-noise ratio and high data resolution is desirable, and an airship can achieve both by providing a low turbulent environment at low speeds. Note that the use of ducted. fans or directional propellers or other directed propulsion systems can allow the airship 12. 12′ to fly a geophysical survey at low speeds as maneuvering the airship does not require speed to generate air flow over a rudder or other control surface. Furthermore, airships that do not depend upon aerodynamic lift have lower levels of turbulence than other aircraft platforms, which results in lower acceleration induced noise, enabling better resolution and lower noise levels within signals.

Low speed surveying can provide safety precautions. For example, many terrain obstacles may be present when conducting low flight surveys; however, while also flying at low speeds, the airship can maneuver about the terrain more easily. Further, areas that may not be surveyable using an aircraft can be surveyed using an airship. For example, planes may not be able to fly close enough to areas with steep hills or with varying terrain, whereas an airship may be able to more effectively maneuver such terrain.

Using an airship to collect geophysical data can also allow for longer data collection periods. For example, airships have higher fuel efficiency than a fixed wing aircraft platform at slow speeds, which can result in longer duration and lower cost gravity surveys. An airship may be able to conduct geophysical surveys for several hours or even days before refueling.

In at least some example embodiments, the airship includes a remote control system and autopilot system 222 that allows the airship 12, 12′ and geophysical survey equipment to be operated remotely from a ground based location such that an airborne crew for the airship can be eliminated, or at least reduced in size or skill level. The airship 12, 12′ can be preprogrammed to fly a predetermined survey flight pattern that is monitored by a ground station 220 that communicates over a wireless communications link with the airship remote control and autopilot system 222. The wireless communications link could for example be through communications system 218. Based on information received from GPS sensor systems 214 and Altimeter/LIDAR systems 216 through the wireless communications link, the ground station 220 can accurately monitor the location and progress of the airship 12,12′.

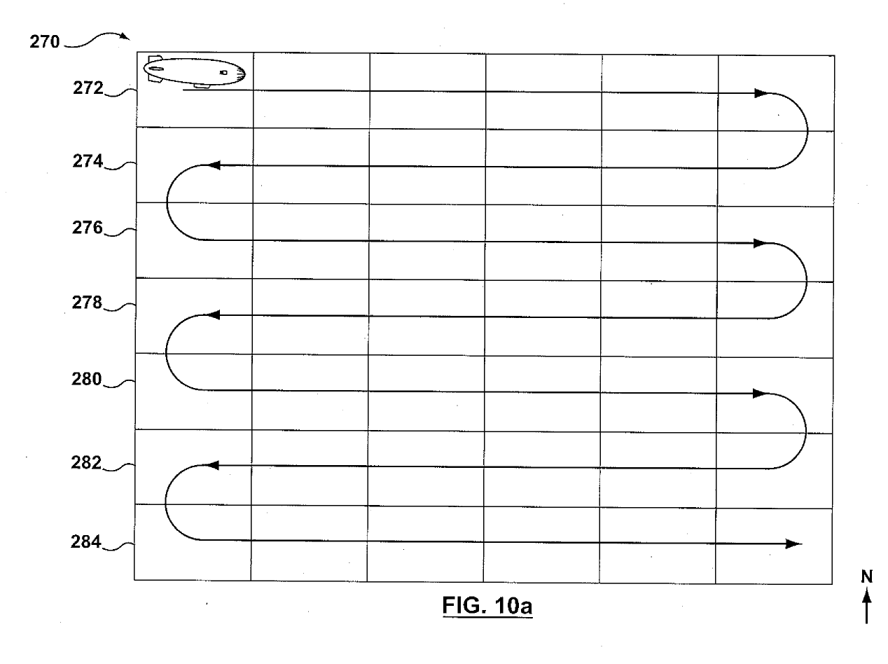

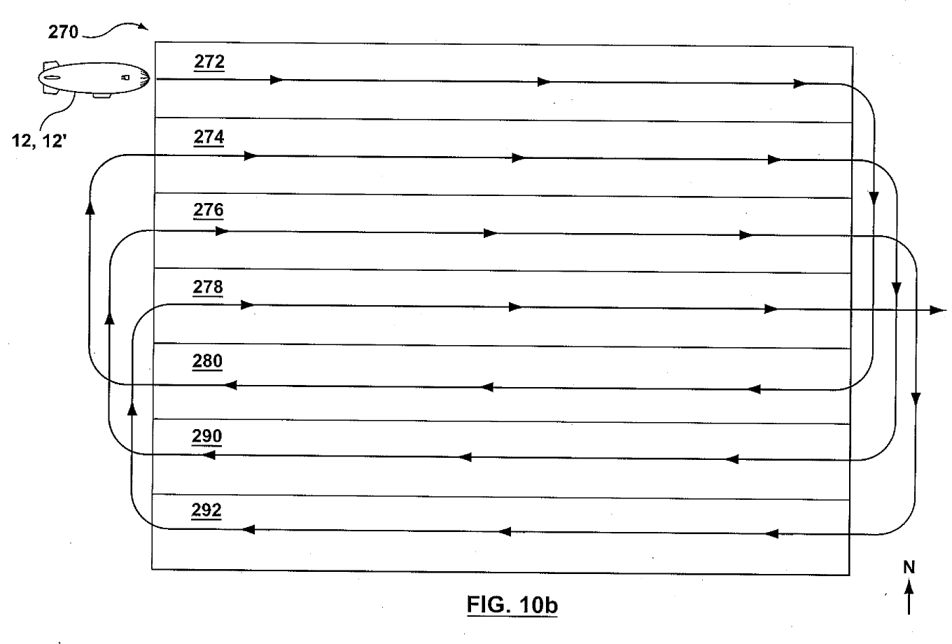

Referring to FIGS. 10a and 10b, in example embodiments geophysical data is recorded and associated with a flight trajectory that is generally a straight line, and FIG. 10a illustrates one example of a survey flight pattern that can be flown by a airship 12, 12′ that is either controlled by an on-board pilot, or which is preprogrammed with a flight pattern, or remotely controlled, or combinations of two or more of the forgoing. A survey area 270 can be divided in a grid, resulting in rows 272-284 corresponding to flight paths, for example. The airship 12, 12′ may then fly a straight path for a certain distance to collect geophysical data along that path. Subsequently, the airship can reverse directions to fly a substantially straight path to collect geophysical data from the terrain that is South of the first flight path. Thus, the airship can fly in a series of nominally parallel survey lines until the total survey area 270 has been covered. In this example, the airship flies from North to South; however, the flight paths could be configured in any manner. The maneuverability of the airship allows for substantially straight lines to be flown. In example embodiments, a survey line could be as long as 1000 km for example, however the length of the survey lines, the inter line spacing, aircraft speed and survey altitude can be selected in dependence on the type of geophysical survey being performed. FIG. 10b shows another flight pattern that can be used to cover survey area 270 in place of the fight pattern of FIG. 10a. The flight pattern shown in FIG. 10b uses what is known as “race-tracking” in which the reverse path is flown along a row that is spaced apart from the immediately preceding row in order to increase the efficiency of the turns made by the airship 12, 12′ when the survey lines are closely spaced. By way of example, in the flight pattern of FIG. 10b, the airship flies east along the first row 272, then makes a 180 degree turn and flies a westward line back along the 5^{th} row 280, then makes a 180 degree turn and flies a eastward line along the 2^{nd} row 274 and so on until the survey area 272 has been covered.

In some example embodiments, a single ground station 220 is used to simultaneously control a plurality of airships 12, 12′ that each have a respective flight pattern. In some example embodiments all or some of the operations performed by grounds station 220 can alternatively be performed from an aircraft based remote control station or a ship-based remote control station.

In some example embodiments, different survey altitudes can be beneficial for different types of geophysical survey equipment. For example, gravity surveys, magnetic surveys and AFMAG surveys may in some situations be more optimally flown at higher heights than TDEM surveys or some radiometry surveys. The airship 12, 12′ provides a versatile platform that can operate over a wide range of survey altitudes for different types.

As noted above, in one example embodiment, the geophysical survey equipment 200 that is used with airship 12 or 12′ includes a an active frequency domain or time domain electromagnetic survey system 210. As known in the art, TDEM geophysical surveying involves generating periodic magnetic field pulses penetrating below the Earth surface. Turning off this magnetic field at the end of each pulse causes an appearance of eddy currents in geological space. These currents then gradually decay and change their disposition and direction depending on electrical resistivity and geometry of geological bodies. The electromagnetic fields of these eddy currents (also called transient or secondary fields) are then measured above the Earth surface and used for mapping and future geological interpretation in a manner that is known. In a frequency domain electromagnetic survey system, the transmitter coil generally continuously transmits an electromagnetic signal at fixed multiple frequencies while the receiver coil measures the signal as a function of time.

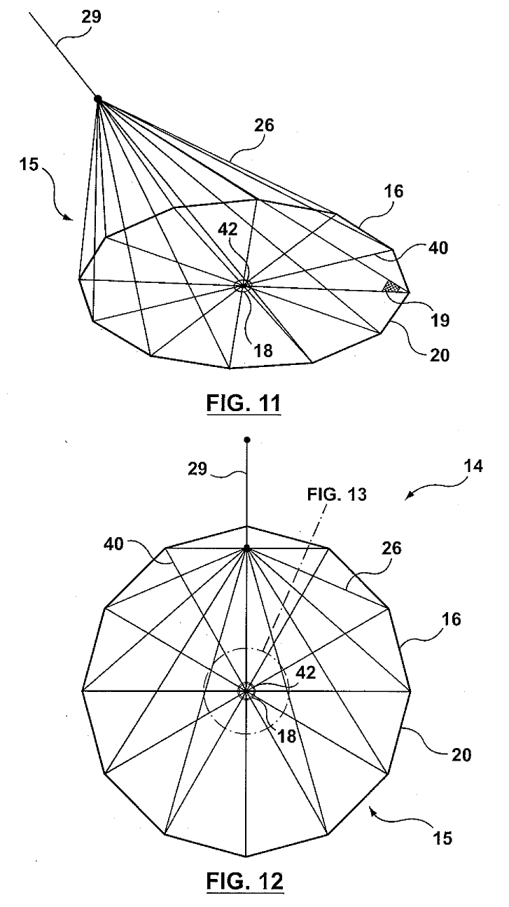

In the embodiment that will now be discussed, electromagnetic survey system 210 is a TDEM system. An airborne TDEM geological survey system is disclosed for example, in U.S. Pat. No. 7,157,914, issued to Morrison et al, the contents of which are incorporated herein by reference, which provides non-exhaustive examples of a airborne TDEM geological survey system 210 that can be used with airship 12, 12′. In one example embodiment System 210 includes tow assembly 14 (FIGS. 1 and 11-13) which includes a flexible frame 15, as illustrated in FIGS. 11 and 12. The flexible frame 15 includes a transmitter section 16 and a receiver section 18 that is substantially concentric with the transmitter section 16. In the illustrated embodiment, the transmitter section 16 includes a flexible support frame 20 that approximates a circular shape and is composed of composite material tubing. The support frame 20 is suspended using rope sections 26 attached to substantially equidistant points along the circumference of the frame 20. The rope sections 26 are attached to a central tow cable 29.

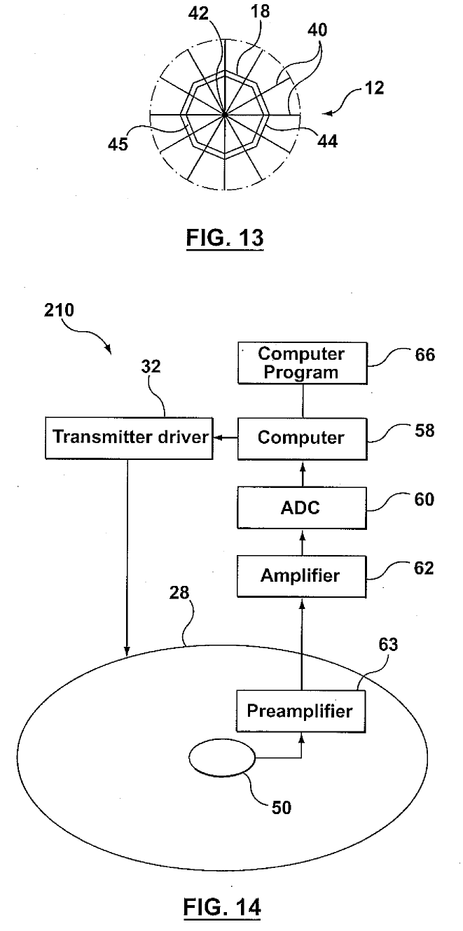

The support frame 20 supports a multi-turn transmitter loop or coil 28 (See FIG. 14). In the embodiment shown in FIGS. 11 and 12, the transmitter coil 28 is located inside tubing that forms the support frame 20.

In at least some example embodiments, the flexible frame 20 includes a small non-metallic flight stabilizer fin 19 and the support cables 26 are formed with different lengths to provide a desired flight orientation for the tow assembly.

In the illustrated embodiment a series of tension ropes 40 are attached to the support frame 20 at various circumferential points and then connected to a central hub 42. The tension ropes 40 provide some rigidity to the support frame 20, and also support the receiver section 18.

As shown in FIG. 13, the receiver section 18 is made up of a plurality of interconnected receiver tube sections 44 providing a receiver frame 45 that is concentric with the support frame 20. These receiver tube sections 44 are made of plastic and are similar in construction to, but smaller than, the tube sections that provide the structure of the support frame 20. The various receiver tube sections 44 include straight sections interconnected by elbow sections. In accordance with one example embodiment, the receiver frame 45 is mounted on the tension ropes 40. The receiver frame 45 houses a sensor coil or sensor loop 50 (see FIG. 14.)

FIG. 14 illustrates electrical and processing components 31 of the EM time domain survey system 210. An electronic transmitter driver 32 that feeds the transmitter coil 28 is installed in a gondola 148 of the airship 12. The transmitter driver 32 is connected to the transmitter coil 28, for example by wiring the transmitter coil 28 to the transmitter driver 32 along the central tow cable 29 and at least one of the ropes 26 supporting the support frame 20. In one example embodiment, the sensor coil 50 output is connected to a non linear preamplifier 63 mounted in a box on the shell 52 outer surface. The processing components 31 include a signal-processing computer 58 and an analog to digital converter device (ADC) 60. The output of the sensor coil 50 is connected through preamplifier 63, a further amplifier 62, low pass filter 64 and the ADC 60 to the computer 58. The ADC 60 converts the analog data produced by the sensor coil 50 and preamplifier in combination to produce digital data for digital data conversion as described below. In an example embodiment, other than the transmitter coil 28, receiver coil 50 and preamp 63, all of the electrical and processing components 31 are located in the gondola 148 of the airship 12, with the result that metallic parts except coil wires and the preamplifier 63 are generally concentrated in the airship 12 far from field generating and the sensor components of the tow assembly 14, reducing noise from parasitic eddy currents.

In operation, the transmitter coil 28 sends a pulse in an “ON” interval, and in an “OFF” interval the receiver coil 50 senses the earth response to the transmitted pulse. The signal from the sensor coil 50, which is proportional to dB/dt, goes through the amplifier 62 and low pass filter 62. The ADC 60 continuously converts the analog signal to digital data. The computer 58 includes a microprocessor and memory and has an associated computer program 66 that configures it to analyze the digitized survey signals to produce survey data. In an example embodiment, a GPS receiver 214 is positioned on the receiver coil structure of the tow assembly 14 to provide accurate location information for the receiver coil.

Other examples of tow assemblies that can be suspended from the airship 12, 12′ for use in geophysical surveys are shown in U.S. patent application Ser. No. 12/036,657 filed Feb. 15, 2008, the entire contents of which are incorporated herein by reference.

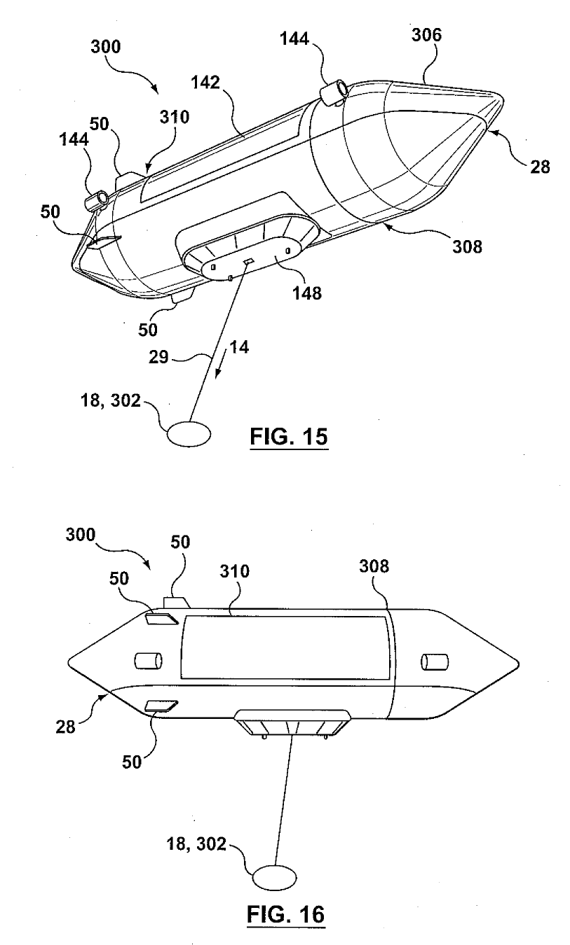

In at least some example embodiments, parts or components of the geophysical survey equipment can be integrated into the body of the airship 12, 12′. By way of example, FIGS. 15 and 16 show an airborne geophysical survey system 300 according to an example embodiment of the invention in which components of the above discussed TDEM system have been integrated into the body of a non-rigid airship 306. The airship 306 and the TDEM system and the rest of the airborne geophysical survey system 300 of FIGS. 14 and 15 are similar is structure and operation to the airship 12, 12′ and TDEM system 210 and the rest of the airborne geophysical survey system 10 discussed above except for differences that will be apparent from the following description and the FIGs.

In the survey system 300 shown in FIGS. 15 and 16, the vertical dipole transmitter coil 28 of the TDEM system 210 has been removed from the tow assembly 14 and instead provided around a lower portion of the body of airship 306. In particular, the transmitter coil 28 is extends horizontally around the perimeter of a lower portion of the gas envelope 142. The transmitter coil 28, which is supported by the gas envelope 142, can be secured directly to the gas envelope 142 by one or more types of fasteners, including for example a series of ropes or loops secured at spaced intervals around the perimeter of the gas envelope 142. In an example embodiment, the transmitter coil 28 is wound around the gas envelope 142 such that the coil 28 is substantially horizontal when the airship 306 is flown level to the terrain. The receiver coil 18 portion of tow assembly 14 remains suspended from the gondola 148. By removing the transmitter coil 28 and its associated support structure from the tow assembly 14, the configuration shown in FIGS. 15 and 16 can reduce the size of the tow assembly 14 as well as the aerodynamic drag placed on the airship by the tow assembly, which can in turn reduce noise introduced into the TDEM system 210 by towing a large bird. Additionally, the total weight of the airborne TDEM system 210 can be reduced by removing the support structure for the transmitter coil 28 from the tow assembly 14.

Although shown wrapped around the lower portion of the gas envelope 142 at a location that is about ¼ of height of the airship 306, the transmitter coil 28 can in other embodiments be located at other locations around the horizontal perimeter of the airship 306 and will typically be arranged not to interfere with the operation of directional propulsion units 144 or the aerodynamics of the airship 306.

In some example embodiments, in addition to or instead of a vertical axis (Z axis) transmitter coil 28, the TDEM system 210 may also have one or more horizontal axis transmitter coils that are secured to and supported by the gas envelope 142 in a manner similar to transmitter coil 28. By way of example, FIGS. 15 and 16 show two substantially orthogonal transmitter coils 308 and 310 each having a respective substantially horizontal dipole axis. The first horizontal axis transmitter coil 308 is vertically wrapped around a perimeter of the gas envelope 142 such that the dipole axis of the coil 308 is substantially parallel to the direction of travel of the airship. The second horizontal axis transmitter coil 310 is secured in a loop along one side surface of the airship such that the dipole axis of the coil 310 is substantially horizontally oriented perpendicular to the direction of travel. Additionally, the sensor structure 18 could house multiple sensor coils at orthogonal angles to each other, rather than just a single coil, to measure EM fields in the X and Y directions in addition to the Z direction.

In some example embodiments, a frequency domain electromagnetic geophysical survey system could be used as an active electromagnetic survey system in place of a TDEM system. In some example embodiments, the transmitter coils may be omitted and the receiver coil 18 may be a sensor for an AFMAG system such as disclosed in above mentioned U.S. Pat. No. 6,876,202.

In some example embodiments, one or more sensors or receiver coils could be mounted to the gas envelope 142 in place of or in addition to transmitter coils. For example, in one example embodiment, the coils 28, 308 and 310 shown in FIGS. 15 and 16 are used as receiver coils for passive AFMAG system 208.

Although coils 28, 308 and 310 have been described in the embodiment of FIGS. 15 and 16 as being directly secured to and supported by the gas envelope of a non-rigid airship in which gas pressure rather than an internal structure defines the airship shape, in at least some example embodiments a rigid airship having an internal support structure, such as a Zepplin NT for example, could be used as a platform for the geophysical survey equipment with one or more of coils 28, 308 or 310 being present and supported by the body of the rigid-type airship.

In some example embodiments, magnetometer sensors 302 of magnetometer system 204 are suspended by a tow cable 29 from the gondola of airship 12, 12′ or 306.

It will be noted that the airship 300 of FIGS. 15 and 16 has a body shape that is cylindrical in the center, with conical end sections, as compared to the more elliptical shape of the airships 12, 12′. Airship 300, which in the illustrated embodiment has at least five stabilizer fins 50 spaced about its tail end, represents a variation on the body shape of a non-rigid airship that can be used in accordance with some example embodiments of the invention.

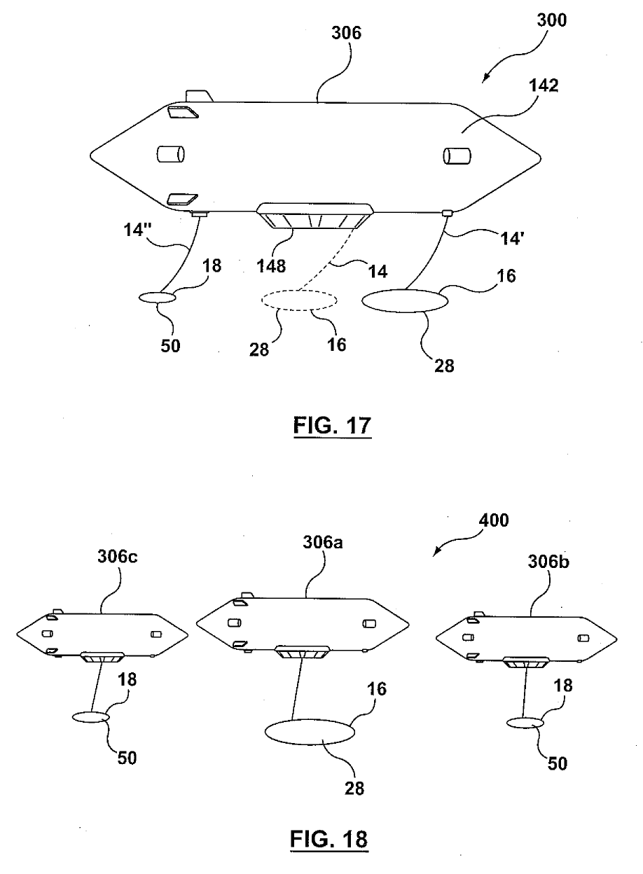

In another example embodiment, multiple tow assemblies that have geophysical survey equipment are suspended from airships 12, 12 or 300 as shown in FIG. 17. By way of example, in FIG. 17, a first tow assembly 14′ is suspended closer to a front end of the airship 300 than a second tow assembly 14″. The leading tow assembly 14′ includes the transmitter section 16 of the TDEM survey system 210, and the trailing tow assembly 14″ includes the sensor or receiver section 18. Although the leading and trailing tow assemblies have been shown as being anchored to points on the gas envelope 142, at least one of the assemblies could alternatively be secured to the gondola 148. In this regard, a phantom line representation shows an alternative location for the leading tow assembly 14′ in which the transmitter section 16, which will typically house a larger coil and weigh more than the receiver section 18, is suspended from the gondola 148. In some embodiments, larger spacing between the transmitter coil and receiver coil in a TDEM survey system 210 can provide different survey data than might otherwise be available when the transmitter and receiver are suspended from a common tow assembly, and such larger spacing is permitted by the dual tow assembly configuration of FIG. 17. the multiple tow assemblies 14′, 14″ could be used with other survey equipment instead of or in addition to TDEM survey equipment—for example, a magnetometer could be suspended from one of the tow assemblies and an AFMAG sensor coil suspended from the other.

FIG. 18 illustrates yet another example embodiment of a geophysical survey system 400. In some applications it may be desirable to get EM survey data from two or more sensors that are at different locations relative to the transmitter coil. In this regard, the survey system 400 of FIG. 18 includes a group of airships 306a, 306b and 306c flying together to conduct a geophysical survey. Although three airships are shown in FIG. 18, other embodiments may include only two airships operating together (for example with one airship towing two receiver assemblies spaced apart from each other), or more than three airships operating together. Each of the airships 306a, 306b or 306c can be identical to or similar to non-rigid airships 12, 12′ or 306 described above. Alternatively, in some example embodiments, airships 306a, 306b or 306c can be rigid airships.

In the embodiment of FIG. 18 the receiving and transmitting sections 16 and 18 of the TDEM survey system 210 have been separated and distributed among multiple airships. In particular, one airship 306a carries or tows the TDEM transmitter structure 16, and two other airships 306b and 306c each tow a respective TDEM sensor or receiver structure 18. All of the airships 306a, 306b, and 306c are equipped with GPS systems 214 and altimeter/LIDAR systems 216 such that the location of the TDEM transmitter or sensor equipment of each airship can be tracked and time stamped with GPS time for real time or future processing, and the operation of the three airships 306a, 306b and 306c their respective TDEM equipment coordinated in real time.

In example embodiments, the airships 306a, 306b and 306c are each in communication with each other directly or through a ground station or satellite or combinations of the forgoing through respective wireless communications systems 218, and each have a respective TDEM control computer 58 (FIG. 14) and associated circuitry for controlling operation of the TDEM transmitter coil 28 (in the case of airship 306a) or receiver coil 50 (in the case of airships 306b and 306c). In one example embodiment the TDEM control computer 58 of the transmitter airship 306a is configured to transmit a signal through communications systems 218 to indicate to receiver airships 306b and 306c transmitter ON-pulse/OFF-pulse timing so that the TDEM control computers 58 of the receiver airships 306b and 306c can sense the earth response to the transmitted pulse during the transmitter “OFF” interval. The transmitter and receiver data, including transmitter pulse information and sensed receiver information, as well as GPS/altimeter/LIDAR information for each of the respective airships 306a, 306b and 306c can be stored locally on the respective airships and then combined at a later time for processing, or can alternatively or additionally be transmitted in real time to a central processing computer that may be at a base station or on-board one of the airships 306a, 306b. 306c. In some example embodiments, TDEM geophysical survey data acquired from the receiver for receiver airship 306b is processed at the TDEM computer 58 on-board that airship, and the TDEM geophysical survey data acquired from the receiver for receiver airship 306c is processed at the TDEM computer 58 on-board that airship. The data from the two receiver airships 306b and 306c can then be compared and geophysical information extracted from each of the two data sets and the data resulting from their comparison.

In one example embodiment, in a multiple airship survey group such as shown in FIG. 18, the configuration or payload specifications of each of the airships 306a, 306b, 306c in the group is selected to maximize operational and cost efficiencies in dependence on the role played by the airship. For example, in the airship survey group of FIG. 18, the transmitter airship 306a can be larger and/or have more powerful propulsion units relative to the receiver airships 306b and 306c as the transmitter assembly 16 will typically be larger and heavier than the receiver assemblies 18.

In one example embodiment as shown in FIG. 18, the airships 306b, 306a and 306c fly in tandem conducting survey lines that are similar to those shown in FIGS. 10a or 10b, with receiver airship 306b leading receiver airship 306a, which in turn leads receiver airship 306c. In one example embodiments, location information about the relative location of the airships (acquired for example through the airships' respective GPS/altimeter/LIDAR systems) is exchanged between the airships and/or between the airships and a ground control station 220 (FIG. 9) such that the airships' respective autopilot systems 222 can control the airships to maintain a predetermined spacing and pattern relative to each other. In one example embodiment, one of the airships (for example the leading airship 306b) is piloted by an on-board pilot with or without the assistance of an autopilot system 222, and the other airships (for example trailing airships 306a and 306c) are piloted by their respective remote control/autopilot system 222 based on signals received from the human-piloted airship to maintain a predetermined spacing and pattern relative among the airships in the survey group.

Although FIG. 18 shows the transmitter airship 306a as being in the center of a tandem airship group, in some example embodiments the transmitter airship 306 could lead the group. Additionally, in some embodiments the group formation could be different than just a straight tandem line. For example, among other formations, different air ships could be at different altitudes in the group and/or the group could have a flying geese V-shaped formation,

Although the airship survey group of FIG. 18 is shown as carrying active EM geophysical survey equipment and in particular TDEM survey equipment, airships in a survey group could be used to perform other types of geophysical surveys as well. The remotely controlled geophysical airship survey method and systems, and multiple airship group survey method and systems, described herein could also be applied to rigid airships having an internal support structure.

In each of the above-describes embodiments, transmitter coil and receiver coil features such as wire gage, loop size or diameter and number of turns can be selected using know techniques.

Patents and patent applications and other publications disclosed herein, including those cited in the Background of the Invention, are hereby incorporated by reference. Other embodiments of the invention are possible. Although the description above contains many specificities, these should not be construed as limiting the scope of the invention, but as merely providing illustrations of some of the presently preferred embodiments of this invention. Thus the scope of this invention should be determined by the appended claims and their legal equivalents. Therefore, it will be appreciated that the scope of the present invention fully encompasses other embodiments which may become obvious to those skilled in the art, and that the scope of the present invention is accordingly to be limited by nothing other than the appended claims, in which reference to an element in the singular is not intended to mean “one and only one” unless explicitly so stated, but rather “one or more.” All structural, chemical, and functional equivalents to the elements of the above-described preferred embodiment that are known to those of ordinary skill in the art are expressly incorporated herein by reference and are intended to be encompassed by the present claims. Moreover, it is not necessary for a device or method to address each and every problem sought to be solved by the present invention, for it to be encompassed by the present claims. Furthermore, no element, component, or method step in the present disclosure is intended to be dedicated to the public regardless of whether the element, component, or method step is explicitly recited in the claims.

What is claimed is:

1. A method for geophysical surveying comprising:
providing a non-rigid airship having a self-supporting gas envelope and propulsion units coupled to the gas envelope, the propulsion units being configured to control the steering and altitude of the airship without the aid of a rudder or elevators;
providing geophysical survey equipment on the airship; and
collecting geophysical data using the geophysical survey equipment while flying the airship.

2. The method of claim 1 wherein the airship includes a gondola attached to an underside of the gas envelope, and the geophysical survey equipment includes a GPS receiver located in the gondola, the method comprising collecting positional information for the geophysical survey equipment based on signals received by the GPS receiver through the gas envelope.

3. The method of claim 1 wherein providing geophysical survey equipment comprises providing an active electromagnetic geophysical survey system that comprises a transmitter coil and a sensor for sensing ground response to signals transmitted by the transmitter coil.

4. The method of claim 3 wherein providing an active electromagnetic geophysical survey system comprises suspending a tow assembly from the airship, the tow assembly including the transmitter coil and the sensor.

5. The method of claim 3 wherein providing an active electromagnetic geophysical survey system geophysical survey system comprises securing a transmitter coil to the gas envelope of the airship.

6. The method of claim 3 wherein providing an active electromagnetic geophysical survey system comprises suspending a first tow assembly from the airship that includes the transmitter coil and suspending a second tow assembly from the airship that includes the sensor.

7. The method of claim 1 wherein providing geophysical survey equipment comprises securing one or more components of the geophysical survey equipment directly to the gas envelope of the airship.

8. The method of claim 7 wherein securing some of the geophysical survey equipment to the gas envelope comprises securing a plurality of transmitter coils about a perimeter of the gas envelope with substantially orthogonal dipole axes relative to each other.

9. The method of claim 1 comprising:
providing a remote control system on the airship for remotely controlling the propulsion units; and
controlling the flight of the airship from a remote location using the remote control system while collecting the geophysical data.

10. The method of claim 8 wherein the remote control system includes an autopilot system, the method including preprogramming the autopilot system to fly a predetermined flight pattern while collecting the geophysical data.

11. The method of claim 1 comprising:
providing a second non-rigid airship having a self-supporting gas envelope and propulsion units coupled to the gas envelope, the propulsion units being configured to control the steering and altitude of the airship without the aid of a rudder or elevators;
providing further geophysical survey equipment on the second airship;
controlling the flight of the airship and the second airship so that they fly a geographical survey of a survey area while remaining within a predetermined range of each other.

12. The method of claim 11 wherein providing further geophysical survey equipment on the second airship comprises providing a transmitter coil for an active electromagnetic geophysical survey system on the second airship and providing geophysical survey equipment on the airship comprises suspending a tow assembly from the airship, the tow assembly including a sensor for measuring ground response to signals from the transmitter coil.

13. A geophysical surveying system comprising:
a non-rigid first airship having a self-supporting gas envelope and propulsion units coupled to the gas envelope, the propulsion units being configured to control the steering and altitude of the first airship without the aid of a rudder or elevators; and
geophysical survey equipment on the first airship.

14. The system of claim 13 wherein the first airship includes a gondola attached to an underside of the gas envelope, and the geophysical survey equipment includes a GPS receiver located in the gondola and positioned to receive signals from GPS satellites through the gas envelope.

15. The system of claim 13 wherein the geophysical survey equipment includes an active electromagnetic geophysical survey system, the geophysical survey system including a tow assembly suspended from the first airship that includes a transmitter coil and a receiver coil.

16. The system of claim 15 wherein the geophysical survey system comprises multiple transmitter coils secured to and supported by the gas envelope of the first airship, the transmitter coils being located substantially at orthogonal angles to each other.

17. The system of 13 wherein the geophysical survey equipment includes an active electromagnetic geophysical. survey system, the geophysical survey system including a first and second tow assemblies suspended from the first airship at spaced apart locations, the first tow assembly including a transmitter coil of the geophysical survey system and the second tow assembly including a receiver coil of the geophysical survey system.

18. The geophysical surveying system of claim 13 comprising:
a non-rigid second airship having a self-supporting gas envelope and propulsion units coupled to the gas envelope, the propulsion units being configured to control the steering and altitude of the second airship without the aid of a rudder or elevators; and
a transmitter coil secured to the second airship for transmitting electromagnetic pulses to induce eddy currents in a surveyed terrain;
wherein the geophysical survey equipment on the first airship includes a receiver coil for measuring signals from the surveyed terrain.

19. The geophysical surveying system of claim 18 wherein the second airship is larger than the first airship.

20. The geophysical surveying system of claim 18 wherein at least one of the first and second airships includes a control system operative to receive communications signals including location information for the other of the first and second airships and control a flight path of the at least one of the first and second airships to keep it within a predetermined range of the other of the first and second airships.

21. The geophysical surveying system of claim 13 comprising:
a non-rigid third airship having a self-supporting gas envelope and propulsion units coupled to the gas envelope, the propulsion units being configured to control the steering and altitude of the third airship without the aid of a rudder or elevators; and
a second receiver coil secured to the third airship for measuring signals from the surveyed terrain in response to the transmitter coil.

22. A method for geophysical surveying comprising:
providing a first airship with a first set of geophysical survey equipment;
providing a second airship with a second set of geophysical survey equipment that is complimentary to the first set; and
conducting an airborne geophysical survey by flying the first airship and the second airship along a designated flight path within a predetermined range of each other.

23. The method of claim 22 wherein one of the first airship and the second airship is larger than, and carries a larger payload than, the other.

24. The method of claim 22 wherein one of the first airship and the second airship has larger propulsion units than, and carries a larger payload than, the other.

25. The method of claim 22 wherein the first set of geophysical survey equipment includes a transmitter coil for an electromagnetic geophysical survey system and the second set of geophysical survey equipment includes a receiver coil for the electromagnetic geophysical survey system.

26. The method of claim 25 wherein the first airship is larger than the second airship.
